(19) United States
(12) Patent Application Publication
(10) Pub. No.: US 2014/0236964 A1
(43) Pub. Date: Aug. 21, 2014

(54) Systems And Methods For Ranking A Plurality Of Documents Based On User Activity

(71) Applicant: LEXISNEXIS, A DIVISION OF REED ELSEVIER INC., Miamisburg, OH (US)

(72) Inventors: John Alexander Dalessio, Brooklyn, NY (US); Gaurav Mehra, Mason, OH (US); Sanjay Sharma, Mason, OH (US); Mahesh Pendyala, Folsom, CA (US); Ramji Sreenivasan, Miamisburg, OH (US)

(73) Assignee: LexisNexis, a division of Reed Elsevier Inc., Miamisburg, OH (US)

(21) Appl. No.: 13/770,198

(22) Filed: Feb. 19, 2013

(51) Int. Cl. G06F 17/30

(52) U.S. Cl. CPC G06F 17/30011
USPC 707/748

(57) ABSTRACT

Systems and methods for ranking a plurality of documents based on user activity are disclosed. A method includes receiving first user activity data and second user activity data. A first user activity point value is associated with the first user activity. A second user activity point value is associated with the second user activity. The method further includes identifying a first data item based on the first user activity data, identifying a second data item based on the second user activity data, updating a first score of the first data item based on the first user activity point value, updating a second score of the second data item based on the second user activity point value, identifying the plurality of documents based on the first data item and the second data item, and ranking the plurality of documents based on the first score and the second score.

### BACKGROUND

1. Field

The present specification generally relates to ranking documents and, more particularly, to systems and methods for ranking a plurality of documents based on user activity.

2. Technical Background

A user of a computing system may wish for the computing system to identify and present data content that is relevant to the user. For example, when a user utilizes the computing system to perform research (e.g., legal research, factual research, etc.), the user may engage in a research session that generally involves a sequence of user activities (e.g., searching, viewing documents, interacting with presented content, etc.) that the user undertakes in order to locate and view relevant documents pertinent to the user's research objective. A computing system may identify and present documents in a ranked order, such that a user may view documents likely to be more relevant to the user earlier in the research session, which may result in quick identification of the information the user is seeking. Accordingly, a need exists for systems and methods for ranking a plurality of documents.

### SUMMARY

In one embodiment, a method for ranking a plurality of documents based on user activity includes receiving, automatically by a computer, first user activity data indicative of a first user activity and second user activity data indicative of a second user activity. A first user activity point value is associated with the first user activity and a second user activity point value is associated with the second user activity. The method further includes identifying a first data item based on the first user activity data, identifying a second data item based on the second user activity data, updating a first score of the first data item based on the first user activity point value, updating a second score of the second data item based on the second user activity point value, identifying the plurality of documents based on the first data item and the second data item, and ranking the plurality of documents based on the first score and the second score.

In another embodiment, a method for ranking a plurality of documents based on user activity includes receiving, automatically by a computer, first user activity data indicative of a first user activity and second user activity data indicative of a second user activity. A first user activity point value is associated with the first user activity and a second user activity point value is associated with the second user activity. The method further includes identifying a first data item based on the first user activity data, identifying a second data item based on the second user activity data, updating a first score of the first data item based on the first user activity point value, updating a second score of the second data item based on the second user activity point value, identifying a user objective based on the first user activity data, identifying the plurality of documents based on the first data item, the second data item, and the identified user objective, and ranking the plurality of documents based on the first score and the second score.

In yet another embodiment, a system for ranking a plurality of documents based on user activity includes a computing device that includes a non-transitory memory component that stores a set of executable instructions that causes the computing device to receive first user activity data indicative of a first user activity and second user activity data indicative of a second user activity. A first user activity point value is associated with the first user activity and a second user activity point value is associated with the second user activity. The set of executable instructions further causes the computing device to identify a first data item based on the first user activity data, identify a second data item based on the second user activity data, update a first score of the first data item based on the first user activity point value, update a second score of the second data item based on the second user activity point value, identify the plurality of documents based on the first data item and the second data item, and rank the plurality of documents based on the first score and the second score.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 depicts a schematic illustration of a computing network for a system for ranking a plurality of documents based on user activity, according to one or more embodiments shown and described herein;

FIG. 2 depicts a schematic illustration of the server computing device from FIG. 1, further illustrating hardware and software that may be utilized in ranking a plurality of documents based on user activity, according to one or more embodiments shown and described herein;

FIG. 3 depicts a flowchart graphically illustrating a method of ranking a plurality of documents based on user activity, according to one or more embodiments shown and described herein;

FIG. 4 depicts a schematic illustration of a tool list dialog that graphically represents tools operable to display ranked documents, according to one or more embodiments shown and described herein; and

FIG. 5 depicts a schematic illustration of a list view of ranked documents, according to one or more embodiments shown and described herein.

### DETAILED DESCRIPTION

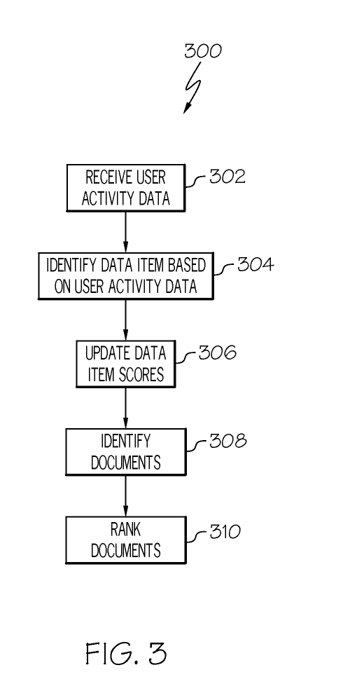

Referring generally to the figures, particularly FIG. 3, embodiments described herein are directed to systems and methods for ranking a plurality of documents based on user activity. The embodiments described herein may receive first user activity data indicative of a first user activity and second user activity data indicative of a second user activity. The embodiments described herein may identify a first data item (e.g., one or more terms, a document, a data construct, metadata, etc.) based on the first user activity data and identify a second data item based on the second user activity data. A first score of the first data item may be updated based on a first user activity point value associated with the first user activity and a second score of the second data item may be updated based on a second user activity point value associated with the second user activity. The embodiments described herein may identify a plurality of documents based on the first data item and the second data item and rank the plurality of documents based on the first score and the second score. By identifying data items based on user activity, assigning scores to the identified data items, identifying relevant documents based on the data items and ranking the documents based on the scores, relevant documents can be identified that share an identified data item with a relatively high score, and are likely to be relevant to the user. Furthermore, by continually updating the score associated with a particular data item as a user performs a sequence of activities, data items that recur among activities may be tracked, such that a data item with a higher score is presumably more relevant to the user than a data item with a low score and may be utilized to identify and rank documents in an order of likely relevance to the user. Various embodiments of systems and methods for ranking a plurality of documents based on user activity are described below.

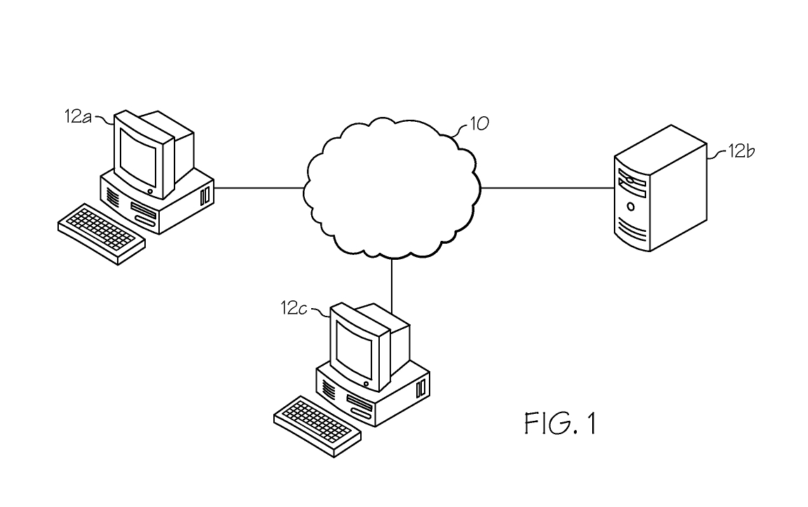

Referring now to the drawings, FIG. 1 depicts an exemplary computing network, illustrating components for a system for ranking a plurality of documents based on user activity, according to embodiments shown and described herein. As illustrated in FIG. 1, a computer network 10 may include a wide area network, such as the internet, a local area network (LAN), a mobile communications network, a public service telephone network (PSTN) and/or other network and may be configured to electronically connect a user computing device 12a, a server computing device 12b, and an administrator computing device 12c.

The user computing device 12a may be used by a user to perform user activities. The user computing device 12a may also be utilized to perform other user functions, such as to provide a graphical user interface for interacting with the computing network and to display, or otherwise communicate, information to the user. Additionally, included in FIG. 1 is the administrator computing device 12c. In the event that the server computing device 12b requires oversight, updating, or correction, the administrator computing device 12c may be configured to provide the desired oversight, updating, and/or correction. The administrator computing device 12c, as well as any other computing device coupled to the computer network 10, may be used to transmit information to the user computing device 12a and/or the server computing device 12b.

It should be understood that while the user computing device 12a and the administrator computing device 12c are depicted as personal computers and the server computing device 12b is depicted as a server, these are non-limiting examples. More specifically, in some embodiments any type of computing device (e.g., mobile computing device, personal computer, server, etc.) may be utilized for any of these components. Additionally, while each of these computing devices is illustrated in FIG. 1 as a single piece of hardware, this is also merely an example. More specifically, each of the user computing device 12a, server computing device 12b, and administrator computing device 12c may represent a plurality of computers, servers, databases, etc.

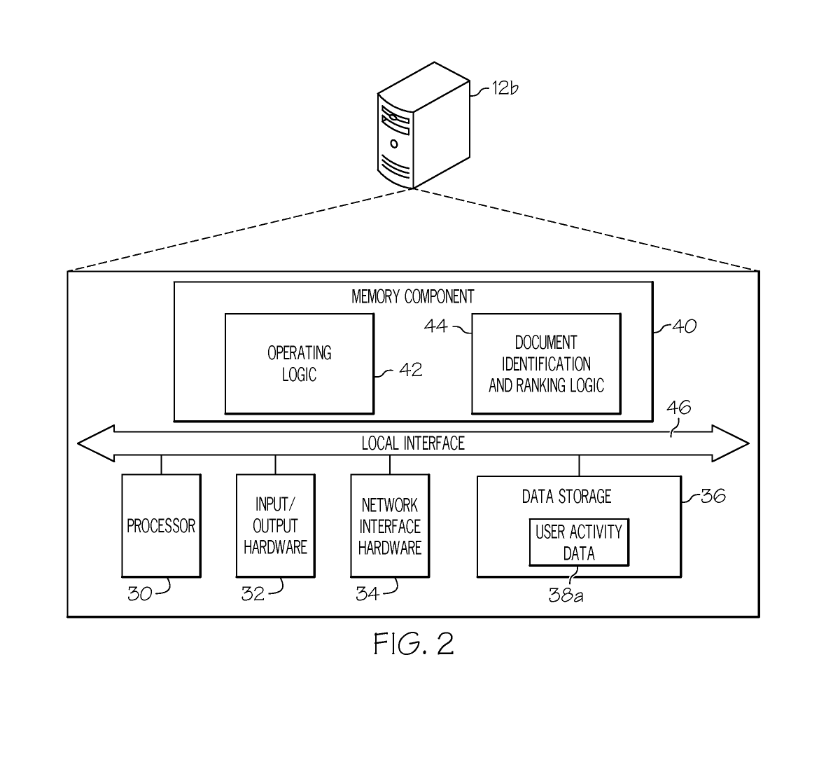

FIG. 2 depicts the server computing device 12b, from FIG. 1, further illustrating a system for ranking a plurality of documents based on user activity, and/or a non-transitory computer-readable medium for ranking a plurality of documents based on user activity embodied as hardware, software, and/or firmware, according to embodiments shown and described herein. While in some embodiments, the server computing device 12b may be configured as a general purpose computer with the requisite hardware, software, and/or firmware, in some embodiments, that server computing device 12b may be configured as a special purpose computer designed specifically for performing the functionality described herein.

As also illustrated in FIG. 2, the server computing device 12b may include a processor 30, input/output hardware 32, network interface hardware 34, a data storage component 36 (which may store user activity data 38a), and a non-transitory memory component 40. The memory component 40 may be configured as volatile and/or nonvolatile computer readable medium and, as such, may include random access memory (including SRAM, DRAM, and/or other types of random access memory), hard disk drives (HDD), flash memory, registers, compact discs (CD), digital versatile discs (DVD), Blu-Ray discs, and/or other types of storage components. Additionally, the memory component 40 may be configured to store operating logic 42 and document identification and ranking logic 44 (each of which may be embodied as a computer program, firmware, or hardware, as an example). A local interface 46 is also included in FIG. 2 and may be implemented as a bus or other interface to facilitate communication among the components of the server computing device 12b.

The processor 30 may include any processing component configured to receive and execute instructions (such as from the data storage component 36 and/or memory component 40). The input/output hardware 32 may include a monitor, keyboard, mouse, printer, camera, microphone, speaker, touch-screen, and/or other device for receiving, sending, and/or presenting data. The network interface hardware 34 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 36 may reside local to and/or remote from the server computing device 12b and may be configured to store one or more pieces of data for access by the server computing device 12b and/or other components. As illustrated in FIG. 2, the data storage component 36 may store user activity data 38a. The user activity data 38a may be stored in one or more data storage devices.

User activity data 38a is indicative of the activities performed by a user of the user computing device 12a. In some embodiments, the user activity data 38a is indicative of user activities, such as information input into the user computing device (e.g., text input via a keyboard or microphone), user manipulation of presented data (e.g., user clicking of a mouse or touching a touch-screen, etc), and the like. For example, in the context of a research session during which a user performs research in order to identify relevant documents, a user may perform a search, view a document, view a related document, download a document, print a document, e-mail a document, fax a document, flag a document, copy text from a document, or click a hyperlink within a document. As another example, in the context of a legal research session performed utilizing the research tools available from LexisNexis, user activity data 38a may be indicative of any of the following user activities: viewing a legal document, viewing a related document, viewing a Shepard's® report, a legal search, a Shepard's® search, viewing a legal issue trail, downloading a document, printing a document, e-mailing a document, faxing a document, flagging a document, copying text from a document, or clicking a hyperlink within a document. In some embodiments, the user activity data 38a may be associated with a particular research session, such that the user activity data 38a is indicative of user activity throughout the research session. In some embodiments, the user activity data 38a may include additional data, such as the duration of a user activity (e.g., how long a document was viewed, how long a user spent performing searches, etc.) or the frequency of a user activity (e.g., a number of times a document was viewed, a number of searches performed, etc.). It should be understood that user activity data 38a may also be indicative of other user activities.

User activity data 38a also includes a user activity point value associated with each user activity. In some embodiments, the user activity point value of a user activity is based on a probativeness of the user activity, such that a more probative user activity has a higher user activity point value than a less probative user activity. As used here “probativeness” refers to a likelihood that user activity data associated with the user activity may be utilized to identify relevant documents. As a first non-limiting example, in the context of a legal research session, performing a legal search may be less probative than viewing a document identified as a result of a legal search. Thus, in the first example, the user activity point value of the less probative legal search may be lower than the user activity point value of the more probative document view. As a second non-limiting example in the same context, viewing a legal issue trail may be more probative than viewing a document. Thus, in the second example, the user activity value of the more probative legal issue trail view may be higher than the user activity point value of the less probative document view. As a third non-limiting example in the same context, viewing a document from within displayed search results may be less probative (and thus have a lower user activity point value) than viewing a document from within another document (e.g., clicking a link to a legal case referenced within a document being viewed by the user). In some embodiments, a document view has a user activity point value of 10, a related document view has a user activity point value of 20, a legal issue trail view has a user activity point value of 30, a legal search has a user activity point value of 5, and a Shepard's® search has a user activity point value of 40. It should be understood that in other embodiments, the user activity point values associated with the user activities may differ than those explicitly set forth herein. For example, in some embodiments, more than one user activity may be associated with the same user activity point value. In some embodiments, a user activity that is not probative may have a user activity point value of 0. In some embodiments, the user activity point value associated with a user activity may be fixed such that the user activity point value is the same for all user activities of the same type (e.g., the user activity point value for all document views may be the same). In other embodiments, the user activity point value associated with a user activity may depend on the nature of the specific user activity (e.g., a first search that returns many results may have a lower probativeness (and consequently a lower user activity point value) than a second search that returns fewer results), as will be described in further detail below.

Included in the memory component 40 are the operating logic 42 and the document identification and ranking logic 44. The operating logic 42 may include an operating system and/or other software for managing components of the server computing device 12b. Similarly, the document identification and ranking logic 44 may reside in the memory component 40 and may be configured to facilitate the identification and ranking a plurality of documents based on user activity, as will be described in detail below with reference to FIG. 3.

It should be understood that the components illustrated in FIG. 2 are merely exemplary and are not intended to limit the scope of this disclosure. More specifically, while the components in FIG. 2 are illustrated as residing within the server computing device 12b, this is a non-limiting example. In some embodiments, one or more of the components may reside external to the server computing device 12b. Similarly, while FIG. 2 is directed to the server computing device 12b, other components such as the user computing device 12a and the administrator computing device 12c may include similar hardware, software, and/or firmware.

Referring now to FIG. 3 (and FIGS. 1 and 2), a flowchart that graphically illustrates a method 300 of ranking a plurality of documents based on user activity according to one or more embodiments is provided. At block 302, the server computing device 12b receives first user activity data indicative of a first user activity and second user activity indicative of a second user activity from the user computing device 12a. In some embodiments, the first user activity data and the second user activity data may be received by the server computing device 12b and stored as user activity data 38a in the data storage component 36 for later access and/or processing by the server computing device 12b. In some embodiments, the first user activity data and the second user activity data may be received by the server computing device 12b and stored in the memory component 40 for immediate access and/or processing by the server computing device 12b. It should be understood that the first user activity data and the second user activity data may be received simultaneously by the server computing device 12b or may be received sequentially by the server computing device (e.g., when a period of time elapses between the receipt of the first user activity data and the receipt of the second user activity data).

Still referring to FIG. 3, a first user activity point value is associated with the first user activity that is received and a second user activity point value is associated with the second user activity that is received at block 302. As described above, in some embodiments, the first user activity point value or the second user activity point value is based on the type of user activity (e.g., if the user activity is a search, the user activity point value may be a first value; if the user activity is a document view, the user activity point value may be a second value, etc.). In some embodiments, the first user activity point value or the second user activity point value is based on the particular user activity (e.g., if the user activity is a search that returns many results, the user activity point value may be a low value; but if the user activity is a search that returns few results, the user activity point value may be a high value, etc.). It should be understood that in some embodiments, the first user activity point value or the second user activity point value may be based on both the type of the user activity and on the particular user activity (e.g., when the user activity point value starts at an initial value when the user activity is a search and is increased or decreased based on the number of search results.)

At block 304, the server computing device 12b identifies a first data item based on the first user activity data and a second data item based on the second user activity data. In some embodiments in which the user activity is a search including at least one or more search terms, the identified data item may include: at least one of the one or more search terms; a headnote that contains at least one of the one or more search terms; a reasons for citation (“RFC”) that contains at least one of the one or more search terms (e.g., text including at least one of the one or more search terms that indicates the reason why a particular document was cited); another documents cited in such a headnote or RFC (i.e., a headnote or RFC that contains at least one of the one or more search terms); a core term present in such a headnote or RFC (i.e., a headnote or RFC that contains at least one of the one or more search terms), a legal taxonomy topic associated with such a headnote or RFC (i.e., a headnote or RFC that contains at least one of the one or more search terms), and the like.

Still referring to block 304 of FIG. 3, in some embodiments in which the user has already performed a search including at least one or more search terms and the user activity involves accessing a document (e.g., viewing the document, viewing a related document, viewing a Shepard's® report for the document, downloading the document, e-mailing the document, faxing the document, flagging the document, etc.), the identified data item may include: at least a portion of the viewed document that includes at least one of the one or more search terms; a headnote associated with the viewed document that contains at least one of the one or more search terms; a reasons for citation (“RFC”) associated with the viewed document that contains at least one of the one or more search terms; another documents cited in such a headnote or RFC (i.e., a headnote or RFC associated with the viewed document that contains at least one of the one or more search terms); a core term present in such a headnote or RFC (i.e., a headnote or RFC associated with the viewed document that contains at least one of the one or more search terms), a legal taxonomy topic associated with such a headnote or RFC (a headnote or RFC associated with the viewed document that contains at least one of the one or more search terms), and the like.

Still referring to FIG. 3, once the data items have been identified at block 304, the server computing device 12b updates a first score of the first data item based on the first user activity point value and updates a second score of the second data tem at block 306. In some embodiments, the score may be updated by adding the user activity point value to the score. In some embodiments, the score may updated by adding a multiple or fraction of the user activity point value to the first score. In some embodiments, the score is based on the frequency of the data item within the context of the user activity (e.g., when: (i) a user has previously preformed a search including one or more search terms; (ii) the user activity is viewing a document; and (iii) the data item is a first search term of the one or more search terms, then the score may be proportional to the frequency of the first search term within the contents of the viewed document.) In some embodiments, the score of the data item may be set to 0 before any user activity is received.

The first score of the first data item may be continually updated based on user activity so that the first score aggregates user activity associated with the first data item as the user performs various activities. In such embodiments, the first data item may already have a first score as a result of prior user activity. For example, in some embodiments, the server computing device 12b may also receive third user activity data indicative of a third user activity. The third user activity may be associated with a third user activity point value. In such embodiments, after the server computing device 12b receives the third user activity data, the first score of the first data item may be updated based on the third activity point value. By way of example: the first data item may be a headnote containing one or more search terms; the first user activity may be viewing a first document (associated with a first user activity point value); and the third user activity may be viewing a second document (associated with a third user activity point value). In such an example, a first score of the first data item may be updated based on the first user activity when the headnote containing the one or more search terms is associated with the first document, such as by adding the first user activity point value to the first score. Then, the first score of the first data item may be updated based on the third user activity (e.g., by adding the third user activity point value to the first score) when the headnote containing the one or more search terms is associated with the second document. By continually updating the score associated with a particular data item as a user performs a sequence of activities, data items that recur among activities may be tracked, such that a data item with a higher score is likely to be more relevant to the user than a data item with a low score and may be used to identify and rank relevant data content. The second score of the second data item may also be updated in a similar manner.

Once the scores of the data items are updated at block 306, the server computing device 12b identifies the plurality of documents based on the first data item and the second data item at block 308. In some embodiments, the plurality of documents are a plurality of legal documents. However, it should be understood that in other embodiments, the documents may not be legal documents, such as when the documents are news documents, factual documents, articles, webpages, and the like. In some embodiments, each of the plurality of identified documents includes or is associated with at least one of the first data item and the second data item. In some embodiments, each of the plurality of identified documents includes or is associated with both the first data item and the second data item. For example, if the first data item is a first headnote and the second data item is a second headnote, the plurality of documents may be identified as the documents including or associated with either the first headnote or the second headnote. In other embodiments in which the first data item is a first headnote and the second data item is a second headnote, the plurality of documents may be identified as the documents including or associated with one of the first headnote or the second headnote.

Still referring to block 308, in some embodiments, the server computing device 12b may identify a user objective based on the first user activity data and identify the plurality of documents based on the identified user objective. For example, when the first user activity data is indicative of a user viewing a legal brief, the user objective may be identified as drafting a brief. When the user objective is identified as drafting a brief, other briefs may be identified as relevant documents because the user may be looking for additional briefs that may be helpful to the user in drafting a brief.

Still referring to block 308, in some embodiments, the server computing device 12b may identify metadata associated with the first user activity and identify the plurality of documents based on the identified metadata. For example, when the first user activity is viewing a court decision document, metadata may be associated with the viewed court decision document, such as a date of the decision, a jurisdiction, a court that issued the decision, a citation of the court decision document, and the like. In one embodiment in which the first user activity is viewing a court decision document from a particular jurisdiction, the particular jurisdiction may be identified from the metadata associated with the court decision document, and another court decision document associated with the same particular jurisdiction may be identified as one of the plurality of documents.

Still referring to FIG. 3, at block 310, the server computing device 12b ranks the plurality of documents based on the first score of the first data item and the second score of the second data item. In some embodiments in which the first data item has a higher score and the second data item has a lower score, the plurality of documents are ranked such that the first data item having the higher score has a greater weight in the ranking than the second data item having the lower score. By way of example, if the first data item is a first headnote with a score of 40 that was identified within a document on which a Shepard's@ search was performed and the second data item is a second headnote with a score of 5 that was merely identified within one of hundreds of documents returned by a legal search, the first headnote would have a greater weight in the ranking of all identified documents that include either the first headnote or the second headnote (e.g., a document that includes both the first headnote and the second headnote would be ranked higher than a document that includes only the first headnote, which would rank higher than a document that includes only the second headnote).

In some embodiments, the method 300 may be employed by a research assistant tool that tracks user activity data and identifies and ranks documents based on the user activity data, as described in detail above with reference to FIG. 3. In some embodiments, the research assistant tool may only be active when a sufficient amount of user activity has occurred, such that the research assistant tool is confident that identified documents are likely to be relevant to the user. In such embodiments, in addition to receiving first user activity data and second user activity data as described above with reference to block 302, the server computing device 12b may receive a plurality of additional user activity data indicative of a plurality of additional user activities, sum the first user activity point value, the second user activity point value, and the associated user activity point values of the additional user activities to obtain an aggregate user activity point value, and determine whether the aggregate user activity point value exceeds an activation threshold. The server computing device 12b may only identify and rank relevant documents when the aggregate user activity point value exceeds the activation threshold, such that the research assistant tool is confident that identified data content is likely to be relevant to the user, thereby mitigating the chance of identifying content that is irrelevant to the user.

After the plurality of documents are identified at block 308 and ranked at block 310, the ranked plurality of documents may be presented to the user of the user computing device 12a in a number of ways. In some embodiments, the ranked plurality of documents may be presented to the user in the context of a research assistant tool that alerts the user to the existence of identified relevant data content and allows the user to access the ranked plurality of documents in a variety of ways, as will be explained below.

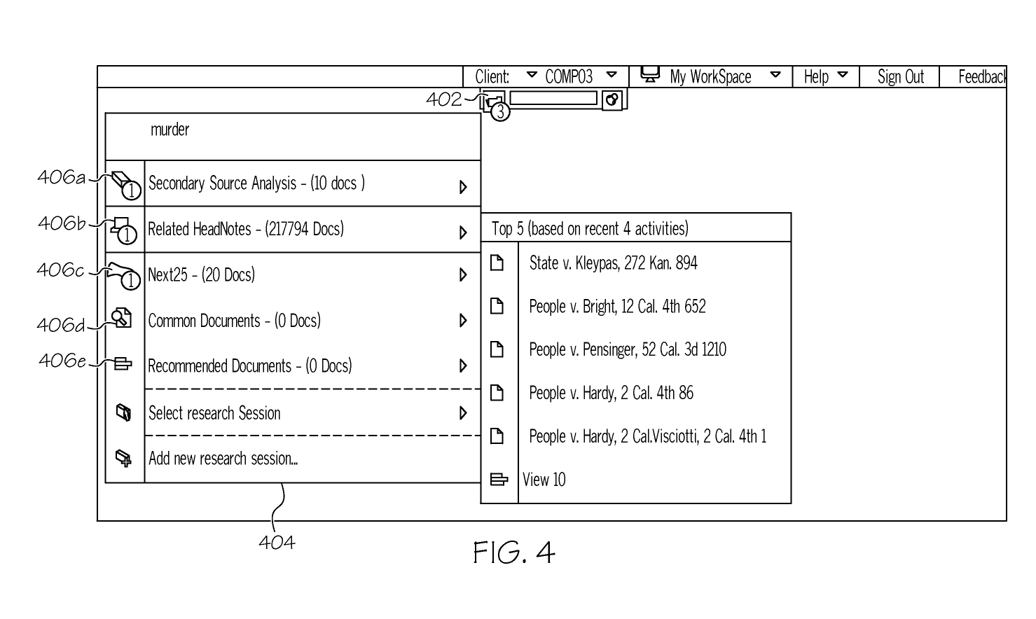

Referring now to FIG. 4, an identified relevant content alert icon 402 may be provided for display on a display device of the user computing device 12a. The identified relevant content alert icon 402 may optionally provide a graphical indication that relevant data content has been identified. In some embodiments, the identified relevant content alert icon 402 may display a number of tools containing identified relevant data content. For example, in the embodiment depicted in FIG. 4, the identified relevant content alert icon 402 displays that 3 tools contain identified relevant data content.

Still referring to FIG. 4, upon clicking or otherwise manipulating the identified relevant content alert icon 402, the user may be presented with a tool list dialog 404, which lists a number of tools that contain identified relevant data content. Each tool may identify relevant data content using different criteria. In some embodiments, the tools include a secondary source analysis tool 406a, a related headnotes tool 406b, a next 25 tool 406c, a common documents tool 406d, and a recommended documents tool 406e. The secondary source analysis tool 406a identifies and ranks relevant secondary source documents based on data items identified from user activities and scores of the data items, according to the method 300 described above with reference to FIG. 3. In some embodiments, the secondary source analysis tool 406a may identify and rank relevant secondary source documents as those documents containing one or more of the data items identified based on user activity or those documents cited or referenced in any document viewed by the user. In some embodiments, the secondary source analysis tool 406a may only identify and rank relevant secondary source documents that have not already been viewed by the user.

The related headnotes tool 406b identifies and ranks relevant documents based on data items identified from user activities and scores of the data items, according to the method 300 described above with reference to FIG. 3. In some embodiments, the related headnotes tool 406b identifies and ranks relevant documents that are associated with headnotes that were identified as data items based on user activity. The related headnotes tool 406b may rank the identified relevant documents based on the scores of the headnote data items. In some embodiments, the related headnotes tool may only identify relevant documents that have not already been viewed by the user.

The next 25 tool 406c identifies and ranks the next 25 most relevant documents based on data items identified from user activities and scores of the data items, according to the method 300 described above with reference to FIG. 3. In some embodiments, the next 25 tool 406c may only identify and rank relevant documents that have not already been viewed by the user.

The common documents tool 406d identifies and ranks documents identified in response to more than one user activity based on data items identified from user activities and scores of the data items, according to the method 300 described above with reference to FIG. 3. In some embodiments, the common documents tool 406d may only identify and rank relevant documents that have not already been viewed by the user

The recommended documents tool 406e identifies and ranks recommended documents based on data items identified from user activities and scores of the data items, according to the method 300 described above with reference to FIG. 3. In some embodiments, the recommended documents tool 406e may only identify and rank relevant documents that have not already been viewed by the user

In the embodiment depicted in FIG. 4, the tool list dialog includes a secondary source analysis tool 406a, a related headnotes tool 406b, a next 25 tool 406c, a common documents tool 406d, and a recommended documents tool 406e. Each of the displayed tools may include a number of documents identified for viewing by the tool. For example, in the embodiment depicted in FIG. 4, there are 217794 documents identified and ranked by the related headnotes tool 406b. In some embodiments, the tool may be grayed out and displayed as inactive when no relevant documents have been identified by the tool. For example, in FIG. 4, the common documents tool 406d is grayed out and inactive, indicating that there are no identified common documents available to the user.

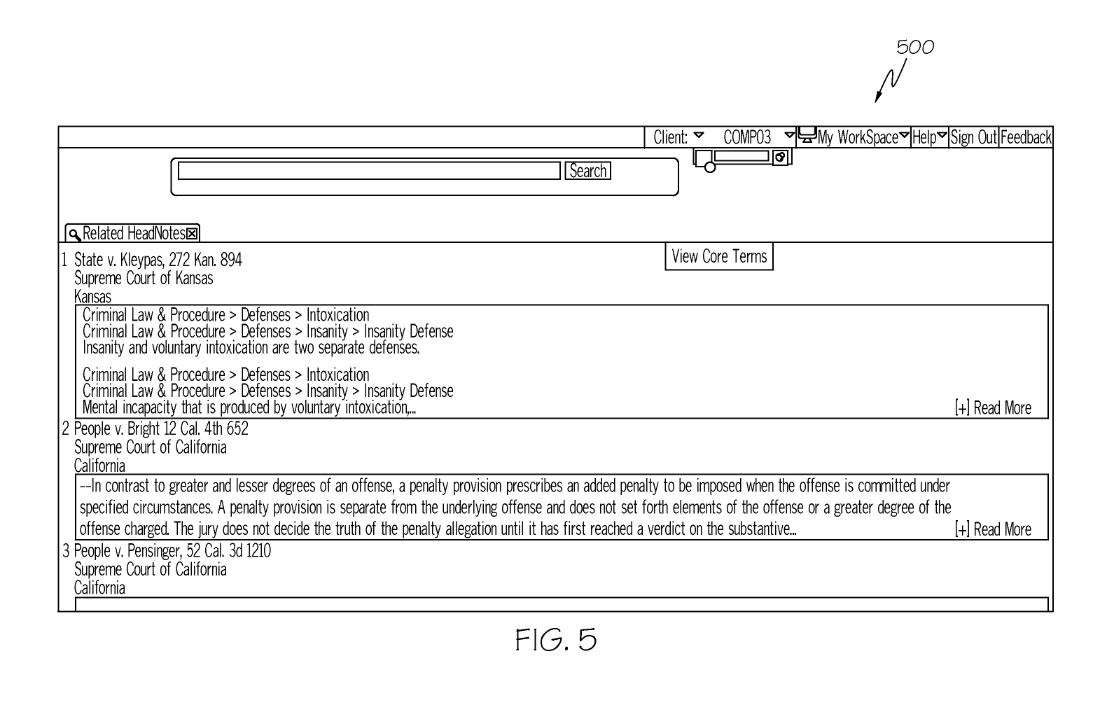

Still referring to FIG. 4, upon clicking on the tool, hovering over the tool with a cursor of the mouse, or otherwise manipulating the tool, a user may be presented with a top 5 dialog box that lists the top 5 ranked documents associated with the tool. The top 5 dialog box may also include a “view 10” field that, when clicked or otherwise manipulated by the user causes a list of the 10 highest ranked documents identified by the tool to be displayed. For example, when a user clicks on the “view 10” field of FIG. 4, a user may be presented with a list 500 of 10 relevant documents, as depicted in FIG. 5. A user may be able to click on any of the displayed documents in the list 500 to view the full text of the document.

It should be understood that embodiments described herein provide for systems and methods for ranking a plurality of documents based on user activity. By identifying data items based on user activity, assigning scores to the identified data items, identifying relevant documents based on the data items and ranking the documents based on the scores, relevant documents can be identified that share an identified data item with a relatively high score, and are likely to be relevant to the user. Furthermore, by continually updating the score associated with a particular data item as a user performs a sequence of activities, data items that recur among activities may be tracked, such that a data item with a higher score is presumably more relevant to the user than a data item with a low score and may be utilized to identify and rank documents in an order of likely relevance to the user.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for ranking a plurality of documents based on user activity, the method comprising:
receiving, automatically by a computer, first user activity data indicative of a first user activity and second user activity data indicative of a second user activity, wherein a first user activity point value is associated with the first user activity and a second user activity point value is associated with the second user activity;
identifying a first data item based on the first user activity data;
identifying a second data item based on the second user activity data;
updating a first score of the first data item based on the first user activity point value;
updating a second score of the second data item based on the second user activity point value;
identifying the plurality of documents based on the first data item and the second data item; and
ranking the plurality of documents based on the first score and the second score.

2. The method of claim 1, further comprising identifying a user objective based on the first user activity data, wherein the plurality of documents is identified based on the identified user objective.

3. The method of claim 1, further comprising identifying metadata associated with the first user activity, wherein the plurality of documents are identified based on the identified metadata.

4. The method of claim 1, wherein the plurality of documents are a plurality of legal documents.

5. The method of claim 1, further comprising:
receiving third user activity data indicative of a third user activity, wherein a third user activity point value is associated with the third user activity; and
updating the first score of the first data item based on the third user activity point value.

6. The method of claim 1, wherein the first user activity is viewing a legal document, viewing a related document, viewing a Shepard's report, a legal search, a Shepard's search, viewing a legal issue trail, downloading a document, printing a document, e-mailing a document, faxing a document, flagging a document, copying text from a document, or clicking a hyperlink within a document.

7. The method of claim 1, wherein the first user activity point value is based on a probativeness of the first user activity, such that the first user activity point value is higher for a higher probativeness first user activity than for a lower probativeness first user activity.

8. The method of claim 1, wherein the first user activity is a search including at least one search term, and wherein the first data item is based on the at least one search term.

9. The method of claim 8, wherein the updated first score is based on a number of identified search results.

10. The method of claim 8, wherein the first data item is: the at least one search term, a headnote containing the at least one search term, or a reasons for citation containing the at least one search term.

11. The method of claim 1, wherein the first score of the first data item is updated based on the first user activity point value by adding the first user activity point value to the first score.

12. The method of claim 1, wherein the first score of the first data item is updated based on the first user activity point value by adding a multiple or fraction of the first user activity point value to the first score.

13. The method of claim 1, wherein the first score is based on a frequency of the first data item within a document.

14. The method of claim 1, further comprising:
receiving a plurality of additional user activity data indicative of a plurality of additional user activities, wherein each user activity has an associated user activity point value;
summing the first user activity point value, the second user activity point value, and the associated user activity point values to obtain an aggregate user activity point value; and
determining whether the aggregate user activity point value exceeds an activation threshold, wherein the plurality of documents is identified when the aggregate user activity point value exceeds the activation threshold.

15. A method for ranking a plurality of documents based on user activity, the method comprising:
receiving, automatically by a computer, first user activity data indicative of a first user activity and second user activity data indicative of a second user activity, wherein a first user activity point value is associated with the first user activity and a second user activity point value is associated with the second user activity;
identifying a first data item based on the first user activity data;
identifying a second data item based on the second user activity data;
updating a first score of the first data item based on the first user activity point value;
updating a second score of the second data item based on the second user activity point value;
identifying a user objective based on the first user activity data;
identifying the plurality of documents based on the first data item, the second data item, and the identified user objective; and
ranking the plurality of documents based on the first score and the second score.

16. The method of claim 15, wherein the first user activity point value is based on a probativeness of the first user activity, such that the first user activity point value is higher for a higher probativeness first user activity than for a lower probativeness first user activity.

17. The method of claim 15, further comprising identifying metadata associated with the first user activity, wherein the plurality of documents is identified based on the identified metadata.

18. A system for ranking a plurality of documents based on user activity, the system comprising:
a computing device that comprises a non-transitory memory component that stores a set of executable instructions that causes the computing device to:
receive first user activity data indicative of a first user activity and second user activity data indicative of a second user activity, wherein a first user activity point value is associated with the first user activity and a second user activity point value is associated with the second user activity;
identify a first data item based on the first user activity data;
identify a second data item based on the second user activity data;
update a first score of the first data item based on the first user activity point value;
update a second score of the second data item based on the second user activity point value;
identify the plurality of documents based on the first data item and the second data item; and
rank the plurality of documents based on the first score and the second score.

19. The system of claim 18, wherein the set of executable instructions further causes the computing device to identify a user objective based on the first user activity data, wherein the plurality of documents is identified based on the identified user objective.

20. The system of claim 18, wherein the set of executable instructions further causes the computing device to identify metadata associated with the first user activity, wherein the plurality of documents is identified based on the identified metadata.
